(19) United States
(12) Patent Application Publication
(10) Pub. No.: US 2010/0129540 A1
(43) Pub. Date: May 27, 2010

(54) METHOD FOR THE PRODUCTION OF A MAGNETIC LAYER ON A SUBSTRATE AND PRINTABLE MAGNETIZABLE VARNISH

(75) Inventor: Oliver Senkel, Munchen (DE)

Correspondence Address: SENNIGER POWERS LLP, 100 NORTH BROADWAY, 17TH FLOOR, ST LOUIS, MO, 63102, US

(73) Assignee: BOURNS, INC., Riverside, CA (US)

(21) Appl. No.: 12/594,394

(22) PCT Filed: May 23, 2008
(86) PCT No.: PCT/EP2008/004108

§ 371 Date: Oct. 2, 2009

(30) Foreign Application Priority Data
Jun. 5, 2007 (DE) 102007026503.6

(51) Int. Cl. H01F 41/14; H01F 1/057

(52) U.S. Cl. 427/130; 252/62.57

(57) ABSTRACT

The current invention relates to a method for the production of a magnetic layer on a substrate, comprising the production of a printable varnish, containing 60 weight-% of neodym iron boron powder, 10 weight-% of ferrite powder, preferably strontium hexaferrite powder, 1.4 weight-% of a catalyst, 1.1 weight-% of a dispersing additive, and as the remainder a matrix, preferably an epoxy polyol matrix. These agents are mixed by means of stirring or kneading, and rolled in a three-roll mill. Preferably, they are applied to a substrate by screen printing, and subsequently pre-cured at 80 to 120° C. for six to twelve hours, and then cured at 200° C. to 220° C. for three hours.

### REFERENCE TO RELATED APPLICATIONS

This application claims priority to German application 10 2007 026 503.6 filed 5 Jun. 2007.

### FIELD OF THE INVENTION

The invention relates to a method for producing a magnetic layer on a substrate as well as to a printable magnetizable varnish.

### BACKGROUND

In measuring, process and control engineering, non-contact sensors are increasingly being used in order to measure the position, alignment, rotation angle or similar of a structural component. In automotive engineering, some examples are linear motion sensors in shock absorbers, rotation angle sensors to determine the steering angle, or throttle flap position sensors, to name just a few.

Among other things, non-contact sensors have the essential advantage over potentiometers with sliding tap that they are virtually not subject to any wear and tear and considerably less sensitive to mechanical vibrations. They are therefore far more reliable and have a longer useful life.

One form of non-contact sensors operates with magnetic layers that are scanned by means of magnetic field sensitive sensors. Examples thereof are described in DE 100 38 296 A1, DE 195 36 433 C2 or DE 10 2004 057 901.

Magnetically active sensor layers can be applied on a substrate in various ways. DE 199 11 186 A1 proposes applying a magnetic layer galvanically on a substrate. This requires high current densities and disposal costs of the electrolyte after use.

DE 31 11 657 C2 dips the substrate to be coated into a melted mass. This melted mass requires an operating temperature of, for example, 960° C. which incurs great expenses in terms of equipment and energy.

DE 24 29 177 A1 describes a method for producing thin magnetic layers through decomposition products of metallic raw material combinations. In this process, highly toxic metal carbonyl compounds of iron and cobalt are pyrolyzed at high temperatures and deposited again on a solid surface. These methods require a high amount of energy, technically sophisticated process steps and involve the handling of harmful chemicals.

Therefore, it has also been suggested to create printable pastes made of magnetic materials. DE 39 15 446 A1 proposes using a neodyme iron boron permanent magnet that is provided with an α-Fe₂O₃ coating to prevent corrosions by subjecting the magnet to an annealing treatment in an oxidizing atmosphere at temperatures between 600° C. and sintering temperature.

DE 10 038 296 A1 and DE 10 309 027 A1 propose magnetically hard powders with maximum remanence and high coercive field strength as magnet materials for which Sr hexaferrite powder and NdFeB powder are being tested. With regard to corrosion resistance and favorable particle size distribution, Sr hexaferrite is preferred over neodyme iron boron. The commercially available NdFeB powders have an average particle size of 200 μm. They are therefore too coarse grained and must be ground prior to use in order to be able to obtain mean particle diameters of about 1 μm. To that end, an elaborate pretreatment of the powders is suggested, with the powders subsequently being bonded in a polymer matrix for the production of the printing paste and with amine hardening epoxides on bisphenol F basis being predominantly proposed for that purpose. The latter permit low-shrinkage hardening of the printed structures and have, in comparison with epoxide resins on bisphenol A basis, lower viscosity which is considered advantageous for the incorporation of a large contents of solids. An additional reduction of viscosity is to be achieved through the use of reactive thinners. Such a material is then applied to substrate materials predominantly by means of stencil printing. In this context, corundum float glass, glass ceramics with low linear expansion coefficients and non-magnetic stainless steel as well as synthetic materials are suggested in particular.

DE 39 211 46 A1 proposes a highly coercive magnet strip in which a magnet layer made of a dispersion of magnetizable particles on the basis of hexagonal ferrites is applied to a carrier foil during a casting process.

In addition to these technical processes, magnetoresistive materials are described as well that are characterized by a nanoscale layer structure. GMR, AMR or TMR components are among the well-known materials in which the distance between the individual layers is smaller than the mean free path length of the electrons. This achieves a coupling effect of the electrons to the neighboring layer, thereby altering the electric resistance of the material (cf. DE 38 20 475 C1).

This effect may also be used for path or angle measurements (cf. DE 10 108 760 A1, DE 10 214 946 A1, DE 10 22 67 A1).

However, these layer structures can be realized only with technically elaborate coating technologies such as spin coating or sputtering.

In addition, lithography and etching techniques are used as well (DE 198 30 343 C1).

DE 697 20 206 T2 (WO 97/038 42; EP 0 898 778 B1) describes a composite magnet made of a magnetic powder, with essentially a neodyme iron boron powder being used and an epoxide being used as binder. Niobium or other metals such as tungsten, chromium, nickel aluminum, copper, magnesium and manganese, gallium, vanadium, molybdenum, titanium, tantalum, zirconium and tin are proposed as other additions as well as additions of carbon, calcium, silicon, oxygen and nitrogen.

A detailed method for the production of permanent magnets made of strontium hexaferrites is described in DE 43 30 197 A1. DE 40 41 962 A1 also describes a polymer-bonded anisotrope magnet material on the basis of fine-particulate hexaferrite and an epoxide amine addition polymer.

Neodyme iron boron compounds with a low cobalt contents are mentioned in U.S. Pat. No. 5,411,608 as well as in US 2003/0217620 A1. The production of magnets made of strontium hexaferrite powder is also described in EP 0 351 775 B1 (DE 689 052 51 T2) as well as in DE 39 21 146 A1.

Practical application for sensors operating with magnetically active material for the measurement of rotation angles or linear paths are described in DE 199 11 702 C2 (rotation angle sensor), DE 199 03 490 C2 (throttle flap position sensor), DE 199 56 361 A1 (rotation angle sensor with GMR magnetic field sensors), DE 100 38 296 A1 (angle measuring device), DE 20 2004 004 455 U1 (linear sensor for an accelerator pedal), DE 197 51 519 C2 (linear sensor), U.S. Pat. No. 6,154,025 (linear sensor) and DE 32 14 794 A1 (length and angle measurement device).

### SUMMARY OF THE INVENTION

The objective of the invention is to create a method for the production of a magnetic layer on a substrate as well as a printable magnetizable varnish that meet the following criteria to a maximum extent:
the hardened varnish should have good magnetic properties, in particular high coercive field strength and high remanence;
the varnish should be as homogeneous as possible;
the varnish should be storable over a longer period of time;
the varnish should be able to be applied with known application methods, including in great layer thicknesses with precise contours; and
production of the varnish should be possible in a cost-effective manner.

When “varnish” is mentioned, it refers to the varnish prior to hardening; if the statements refer to the hardened varnish, it will always be expressly mentioned.

The invention solves these problems by means of the characteristics of patent claims 1 and 10. Advantageous embodiments and further developments of the claims can be found in the subclaims.

### DETAILED DESCRIPTION OF PREFERRED EMBODIMENTS

The varnish in accordance with the invention is composed as follows:
ca. 60% by weight of neodyme iron boron powder;
ca. 10% by weight of ferrite powder, preferably strontium hexaferrite powder;
ca. 1.4% by weight of a catalyst;
ca. 1.1% by weight of a dispersing agent; remnants of a matrix, preferably of an epoxide polyol matrix.

The percents by weight listed are each to be understood with a bandwidth of ca. +/−3%, resulting in the following composition:
58.2 to 61.8% by weight of neodyme iron boron powder;
9.7 to 10.3 by weight of ferrite powder, preferably strontium hexaferrite powder;
1.35 to 1.44% by weight of a catalyst;
1.07 to 1.13% by weight of a dispersing agent;
29.68 to 25.33% by weight of a matrix, preferably of an epoxide polyol matrix.

The varnish contains a solvent in the matrix that evaporates during hardening. Therefore the hardened varnished has a lower percentage share in the matrix due to the then-missing solvent and a higher share of the neodyme iron boron powder, with the latter's share in the hardened varnish amounting to up to 70% by weight.

Based on the extensive trials by the inventor, the composition indicated above was determined to be optimal with regard to the requirements stated in the objective. The saturation polarization of the hardened and magnetized varnish lay at 430 mT, remanence at 202 mT, coercive field strength at 625 KA/m, and the energy product (B×H) at 6.78 mJ/cm³, with magnetized strips with a pole width of 2.5 mm and a layer thickness of 25 μm being applied. Moreover, the varnish produced in this way and not yet completely hardened was storable for several weeks under refrigeration and excellently printable after storage. No separations or sedimentations occurred.

The method in accordance with the invention for the production of a magnetic layer on a substrate entails the following successive steps:
a) mixing of the abovementioned components through stirring or kneading;
b) rolling of the mixture;
c) applying the varnish produced in this manner on a substrate, preferably by means of stencil printing;
d) pre-hardening of the applied varnish at a temperature of between 80° C. and 120° C. for six to twelve hours;
e) subsequent final hardening at a temperature between 200° C. and 220° C. for one to three hours; and
f) magnetizing the hardened layer.

Following step b), a reworking of the rolled mixture may be required, with once again dispersion agents being added depending on the viscosity and an additional rolling being carried out. The rolling following step b) as well as the repeated rolling, if necessary, are preferably done on a three-roll mill.

Following step e), a mechanical reworking of the hardened layer may occur which is preferably done through milling or grinding if the print appearance does not meet the precision requirements.

The pre-hardening is carried out over six to twelve hours and facilitates a controlled evaporation of the solvent of the matrix, thereby preventing any solvent inclusions from remaining and any density gradient from occurring in the material. Following the pre-hardening, a not fully hardened layer is obtained that can still be easily shaped. The pre-hardening with subsequent final hardening will lead to a smooth layer that does not show any holes or inclusions even during a step-by-step milling process.

The neodyme iron boron powder is an alloy of the Nd₂Fe₁₄B type in spherical form that is available from the firm of Magnequench under the designation MQP-S-11-9. This mixture has a particle diameter of 40 μm with a distribution of 35-55 μm.

One problem of this magnetic powder is the fact that no sufficient dispersion occurs in the polymer matrix. For this reason, the ferrite powder is added through mixing in the amount indicated, with a strontium hexaferrite powder (Sr—Fe₃O₄) in the form of sintered particles with a particle size of 5 μm being added in a concrete embodiment.

Following the mixing of the aforementioned components which is done through stirring or kneading, the mixture was milled in a three-roll mill in the concrete embodiment. In this process, the particles were split due to the deagglomeration of larger clusters. Following the milling, no sedimentation of the metal particles could be detected even after a longer storage period, with the varnish still being capable of flowing and thus being processable even after a 12-hour holding time in a refrigerator. Thus, no cross linking occurred during cool storage.

The magnetic layer applied to the substrate was subjected to a moist storage process of 100 hours at a temperature of 40° C. and 95% humidity. The moisture absorption was less than 0.1%. No optical changes in the magnetic layers could be detected, either. Therefore, the magnetic layer is also corrosion resistant.

A commercially available synthetic resin such as epoxide, polyester or polyurethane may be used as polymer matrix, together with an aminic or phenolic hardener. Epoxide was used in the concrete embodiment. In this context, the matrix also contains other additives to speed up the reaction in the form of a catalyst as well as dispersion agents for which commercially available tensides are used. Solvents such as alcohols or ketones are added to the mixture in order to adjust the required printability of the varnish.

Al₂O₃ ceramics or commercially available synthetics such as laminated epoxide/fiber glass plates are preferably used as substrates.

For cases of practical application of sensors, a layer thickness of at least 200 μm should be selected and may go up to 1,000 μm. These layer thicknesses can best be realized through stencil printing.

The pre-hardening to be carried out following the printing step is to be done for six to twelve hours at 80-120° C. Shorter drying times or higher temperatures will lead to undesirable hollow spaces or to the formation of blisters. A controlled evaporation of the solvents is obtained. The subsequent hardening which brings about a complete cross-linking of the substances takes places over a period of one to three hours at 200-220° C.

1-13. (canceled)

14. A method for producing a magnetic layer on a substrate comprising:
applying a mixture comprising a neodyme iron boron powder, a ferrite powder, a catalyst, a dispersion agent, and a matrix to a substrate, wherein the catalyst is a reaction accelerator for the matrix;
hardening the mixture to yield a fully hardened layer; and
magnetizing the hardened layer.

15. The method of claim 1 wherein the hardening comprises pre-hardening at a first lower temperature and final hardening at a second higher temperature.

16. The method of claim 1 wherein the hardening comprises pre-hardening at temperature between 80° C. and 120° C. for six to twelve hours and final hardening at a temperature of between 200° C. and 220° C. for one to three hours.

17. The method of claim 1 wherein the mixture comprises from about 58.2 to about 61.8% by weight of the neodyme iron boron powder, about 9.7 to about 10.3% by weight of the ferrite powder, about 1.35 to about 1.44% by weight of the catalyst, about 1.07 to about 1.13% by weight of the dispersion agent and balance of the matrix.

18. The method of claim 1 comprising:
a) preparing the mixture of from about 58.2 to about 61.8% by weight of the neodyme iron boron powder, about 9.7 to about 10.3% by weight of the ferrite powder, about 1.35 to about 1.44% by weight of the catalyst, about 1.07 to about 1.13% by weight of the dispersion agent and balance of the matrix through stirring or kneading, with the catalyst serving as reaction accelerator for the matrix;
b) rolling of the mixture;
c) applying the mixture on the substrate;
d) pre-hardening of the mixture applied on the substrate at a temperature of between 80° C. and 120° C. for six to twelve hours;
e) final hardening at a temperature of between 200° C. and 220° C. for one to three hours; and
f) magnetizing the fully hardened layer.

19. The method of claim 18 wherein the rolling of the mixture in accordance with step b) occurs on a three-roll mill.

20. The method of claim 18 wherein the application on the substrate in accordance with step c) is done by means of stencil printing.

21. The method of claim 18 wherein the mixture in step a) comprises about 60% by weight of neodyme iron boron powder, about 10% by weight of ferrite powder, about 1.4% by weight of a catalyst, about 1.1% by weight of a dispersion agent, and balance of the matrix.

22. The method of claim 18 wherein the ferrite powder is a strontium hexaferrite powder.

23. The method of claim 18 wherein the matrix is an epoxide polyol matrix.

24. The method of claim 18 wherein the following step b), a reworking of the mixture by means of further additions of dispersion agents is carried out.

25. The method of claim 24 wherein the reworking of the mixture involves an additional rolling.

26. The method of claim 18 wherein following step e) a mechanical reworking of the fully hardened layers occurs by means of milling or grinding.

27. A printable and magnetizable varnish of the following composition:
about 58.2 to about 61.8% by weight of neodyme iron boron powder;
about 9.7 to about 10.3% by weight of ferrite powder;
about 1.35 to about 1.44% by weight of a catalyst;
about 1.07 to about 1.13% by weight of dispersion agent;
the rest: a matrix
with the catalyst being a reaction accelerator for the matrix.

28. The varnish of claim 27 wherein the ferrite powder is a strontium hexaferrite powder.

29. The varnish of claim 27 wherein the matrix is an epoxide polyol matrix.

30. The varnish of claim 27 comprising about 60% by weight of the neodyme iron boron powder, about 10% by weight of the ferrite powder; about 1.4% by weight of the catalyst; and about 1.1% by weight of the dispersion agent.
